(19) United States
(12) Patent Application Publication
(10) Pub. No.: US 2012/0198963 A1
(43) Pub. Date: Aug. 9, 2012

(54) DRIVETRAIN OF A VEHICLE

(75) Inventors: Uwe Griesmeier, Markdorf (DE); Bernhard Sich, Friedrichshafen (DE)

(73) Assignee: ZF FRIEDRICHSHAFEN AG, Friedrichshafen (DE)

(21) Appl. No.: 13/501,145

(22) PCT Filed: Oct. 19, 2010
(86) PCT No.: PCT/EP2010/065695

§ 371 Date: Apr. 10, 2012

(30) Foreign Application Priority Data
Oct. 26, 2009 (DE) 10 2009 045 972.3

(51) Int. Cl. F16H 37/08

(52) U.S. Cl. 74/661; 180/65.21; 903/902

(57) ABSTRACT

A drive-train of a vehicle having an internal combustion engine and a continuously variable transmission for driving under internal combustion engine power and having at least one electric machine for driving under electric power. The electric machine can be coupled, on the drive output side, in such manner that electric driving can take place decoupled from the continuously variable transmission.

This application is a national stage completion of PCT/EP2010/065695 filed Oct. 19, 2010 which claims priority from German Application Serial No. 10 2009 045 972.3 filed Oct. 26, 2009.

### FIELD OF THE INVENTION

The present invention concerns a drive-train of a vehicle.

### BACKGROUND OF THE INVENTION

From automotive technology, drive-trains are known for purely electrically powered vehicles, for vehicles powered only by an internal combustion engine, and also for hybrid vehicles. Vehicles powered exclusively by electricity have the problem of insufficient range because of the limited battery capacity. The range of vehicles powered exclusively by an internal combustion engine is substantially longer, but compared with an internal combustion engine the efficiency of an electric machine is substantially better. Accordingly it makes sense to use a hybrid drive, in which the battery capacity is designed so that most short drives are covered by it but the internal combustion engine drive is used for longer journeys.

### SUMMARY OF THE INVENTION

The purpose of the present invention is to improve a drive-train for a vehicle of the type described at the start, in such manner that during purely electrical driving no unnecessary drag torques occur due to co-rotating components of the internal combustion engine drive.

According to these a drive-train of a vehicle is proposed, which comprises an internal combustion engine and a continuously variable transmission for driving under internal combustion engine power, and at least one electric machine for driving under electric power, wherein on the drive output side the electric machine can be coupled in such manner that electric driving can be carried out decoupled from the continuously variable transmission and from the internal combustion engine.

In this way, during exclusively electric driving of the vehicle no drag torque is caused by unnecessary co-rotation of components of the internal combustion engine drive or the continuously variable transmission, since electric driving takes place without being influenced by the continuously variable transmission so that the good efficiency of the electric machine is maintained.

In an advantageous embodiment variant of the invention it can be provided that the electric machine can be decoupled from the output shaft of the continuously variable transmission by means of at least one shifting element or the like. In this way the connection between the electric machine and the continuously variable transmission can be broken if needs be. It is also possible to use other design means to interrupt the force flow between the continuously variable transmission or internal combustion engine and the electric machine.

To drive under electric power while the internal combustion engine and the transmission are both at rest, it can be provided that on the drive output side, in addition, for example a multi-stage transmission is connected to an axle differential. For example, a 2-gear transmission or the like can be used. In this way the electric drive power can be transmitted to the axle differential, preferably by way of a fixed gear ratio. When the additional multi-stage transmission is used, a further advantage obtained is that even during internal combustion engine driving the available driving range is extended, or the continuously variable transmission used advantageously needs a smaller spread.

An advantageous further development of the invention can provide that the electric machine can be decoupled from the axle differential by means of at least one shifting element or the like. In this way for example, the battery of the vehicle can be charged when the electric machine is switched into generator mode and driven by the internal combustion engine when the vehicle is at rest.

According to a related design feature of the invention it can be provided that the output shaft of the continuously variable transmission is decoupled by a shifting element or the like from the electric machine and can be coupled by the multi-stage transmission to the axle differential. This makes it possible with the proposed drive-train, for the vehicle if necessary to be driven exclusively by the internal combustion engine. For example, if additional drive power is desired the drive power can be boosted, as it is called, by coupling the electric machine. Likewise, to brake the vehicle part of the internal combustion engine power can be used by the electric machine, switched to operate as a generator, for charging the battery.

The shifting elements can be designed in a particularly simple manner if they are actuated, for example, by means of a shifting cylinder or the like so that only one control motor or actuator is needed for the two shifting elements. Other actuating means too can be used for the shifting elements.

When an additional, two-stage transmission is used at the drive output of the drive-train, according to a related further development of the invention one stage can for example be used as a forward gear ratio and the other stage as the reversing gear ratio. This extends the available driving ranges of the drive-train. In design terms this can be done, for example, in such manner that a loose wheel is associated with the output shaft of the continuously variable transmission, which can be connected thereto by a shifting element so that forward driving can be carried out both electrically and under internal combustion engine power. For the reversing gear ratio a loose wheel mounted on the output shaft of the continuously variable transmission can also be associated with the corresponding stage, which at the same time meshes with a drive output gearwheel of the axle differential. The permanent connection between the loose wheel of the output shaft of the continuously variable transmission and the output gearwheel of the axle differential can most simply be enabled by an appropriate spatial arrangement of the shafts relative to one another. When the loose wheel is connected to the output shaft by means of a shifting element, the vehicle can be driven in reverse under internal combustion engine power.

To dampen, for example, the vibrations produced by the internal combustion engine, a vibration damper can be associated, for example, with the input shaft of the continuously variable transmission. To extend the driving ranges of the proposed drive-train, a starting clutch can preferably be associated with the input shaft of the continuously variable transmission. In this way the vehicle can also be started using the internal combustion engine alone. As the starting clutch, for example a centrifugal force clutch can be used. Preferably, a dry-running CVT can be used as the continuously variable transmission.

In summary, in the proposed drive-train the additional, for example two-stage transmission can be used on the one hand to connect the electric machine and on the other hand also to extend the gear ratio range during internal combustion engine drive input. Thus, not only is an advantageous gear ratio provided for electric driving, but also, when driving under internal combustion engine power as well, a lower gear ratio range and a higher gear ratio range are provided, and at the same time the electric machine can operate as a generator or as a motor. Furthermore, the internal combustion engine can be started by the electric machine or also by an additional starter. In all, with the at least two shifting elements provided, which are preferably actuated by a common actuator, at least four driving ranges can be obtained.

### BRIEF DESCRIPTION OF THE DRAWINGS

Below, the present invention is explained further with reference to the drawings, in which various possible embodiment variants of the drive-train according to the invention are represented and which show:

FIG. 1: A first embodiment variant of a drive-train of a vehicle according to the invention;

FIG. 1A: A shifting scheme for the first embodiment variant in FIG. 1;

FIG. 2: A second embodiment variant of a drive-train of a vehicle according to the invention;

FIG. 2A: A shifting scheme for the second embodiment variant in FIG. 2;

FIG. 3: A third embodiment variant of a drive-train of a vehicle according to the invention;

FIG. 3A: A shifting scheme for the third embodiment variant in FIG. 3;

FIG. 4: A fourth embodiment variant of a drive-train of a vehicle according to the invention;

FIG. 4A: A shifting scheme for the fourth embodiment variant in FIG. 4;

FIG. 5: A fifth embodiment variant of a drive-train of a vehicle according to the invention;

FIG. 5A: A shifting scheme for the fifth embodiment variant in FIG. 5;

FIG. 6: A second embodiment variant of a drive-train of a vehicle according to the invention;

FIG. 6A: A shifting scheme for the sixth embodiment variant in FIG. 6;

FIG. 7: A second embodiment variant of a drive-train of a vehicle according to the invention; and

FIG. 7A: A shifting scheme for the seventh embodiment variant in FIG. 7.

### DETAILED DESCRIPTION OF THE INVENTION

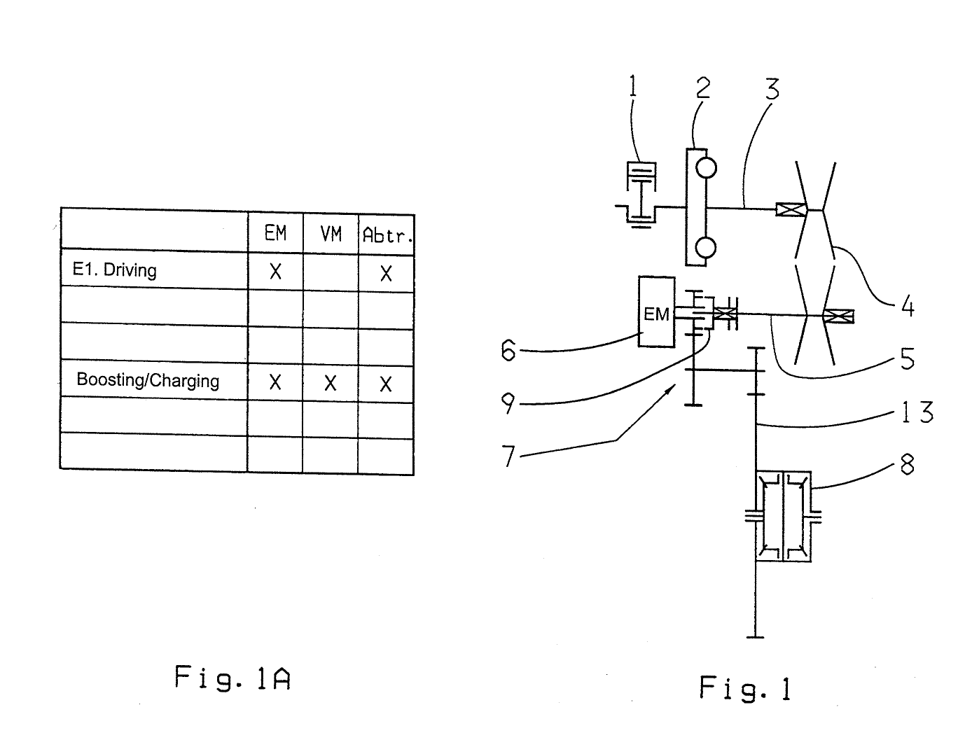

FIGS. 1 to 7 show various possible embodiment variants of a drive-train according to the invention for a vehicle, having an internal combustion engine (VM) 1, a continuously variable transmission 4 and an electric machine 6 (EM), whereas FIGS. 1A to 7A indicate in each case respective shifting schemes for the corresponding embodiment variants. In the shifting schemes, for the functions or driving ranges available in each case the necessary connections of the internal combustion engine 1, the electric machine 6 and/or the drive output or axle differential 8 are indicated by corresponding crosses.

Regardless of the respective embodiment variant, the drive-train of the vehicle (not shown further) comprises the internal combustion engine 1, which is preferably connected, via a vibration damper 2, to an input shaft 3 of the continuously variable transmission 4, preferably a CVT. Associated with the output shaft 5 of the continuously variable transmission 4, directly or indirectly, is the electric machine 6. For purely electric driving the electric machine 6 can be connected by way of an additional, preferably two-stage transmission 7, to an axle differential 8. According to the invention, the electric machine 6 is coupled on its drive output side in such manner that electric driving can be carried out decoupled from the continuously variable transmission 4.

FIG. 1 shows a first embodiment variant of the drive-train, in which the electric machine 6 is directly connected to a stage of the two-stage transmission 7, whereby the output shaft 5 of the continuously variable transmission 4 can be connected by means of a shifting element 9, for example a shifting claw, to the electric machine 6 and thus ultimately to the axle differential 8.

Particularly from the table shown in FIG. 1A it can be seen with this first embodiment variant that, as a driving range, electrically powered driving without connection to the continuously variable transmission 4 or the internal combustion engine 1 is possible, since the electric machine 6 is connected to the drive output (Abtr.) or axle differential 8 by way of the two-stage transmission 7, whereas the shifting element 9 is open and the output shaft 5 of the continuously variable transmission 4 is decoupled from the electric machine 6.

Furthermore, when the shifting element 9 is closed driving under internal combustion engine power is possible, and in addition the electric machine 6 can be charged in order to brake the vehicle or can assist the drive input by so-termed boosting. Thus, with this first embodiment variant the driving ranges boosting/charging are also possible.

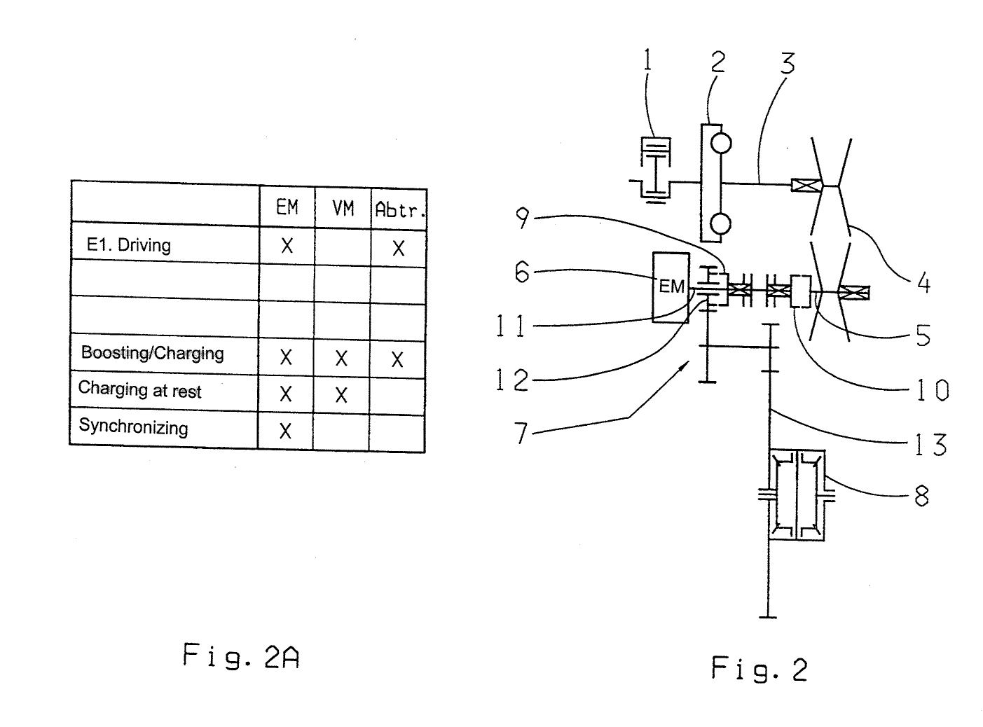

FIG. 2 shows a second embodiment variant of the drive-train, in which the two shifting elements 9, 10 are associated with the output shaft 5 of the continuously variable transmission 4 and the electric machine 6. Associated with the drive output shaft 11 of the electric machine 6 is a loose wheel 12, which meshes with a stage of the additional transmission 7.

From the shifting scheme in FIG. 2A it emerges in particular that when the shifting element 9 is closed and the shifting element 10 is open, pure electric driving is possible as a driving range without connection to the internal combustion engine 1, since by way of the loose wheel 12 connected to its output shaft 11 and the additional transmission 7 the electric machine 6 is connected to the axle differential 8. In addition, with the second embodiment variant internal combustion engine driving can also take place, and to brake the vehicle the electric machine can be charged or it can assist (boost) the drive input of the vehicle.

When the shifting element 9 is open and the shifting element 10 is closed, the electric machine 6 can be connected with the internal combustion engine 1 and at the same time disconnected from the axle differential 8, so that as a driving range, when the vehicle is at rest the battery can be charged by the electric machine 6 operating as a generator (charging while at rest). When the electric machine 6 is disconnected from the axle differential 8 by opening the shifting element 9 and from the internal combustion engine 1 by opening the shifting element 10, as a driving range or transitional state the electric machine 6 can be synchronized in order to adapt the speed of the electric machine 6 to the speed of the internal combustion engine 1. For example, by such synchronizing the speed of the electric machine 6 can be adapted from one condition, such as starting the engine, to the transition toward the next condition, for example electric starting from zero speed. Other synchronization possibilities also exist.

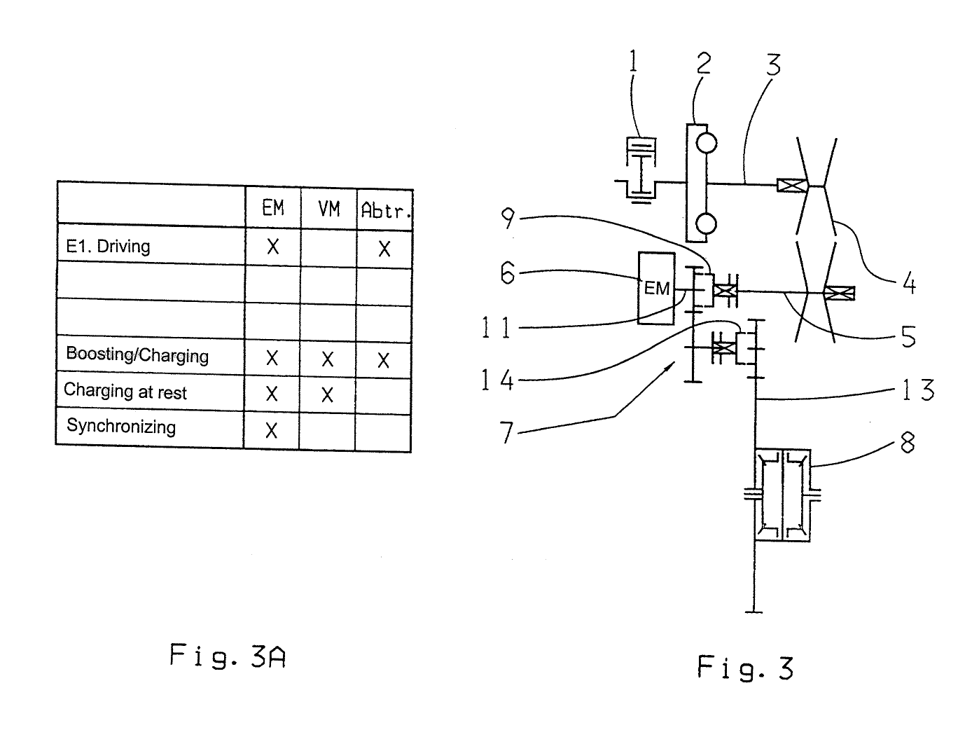

FIG. 3 shows a third embodiment variant in which the shifting element 9 is provided between the output shaft 5 of the continuously variable transmission 4 and the electric machine 6 or one stage of the two-stage transmission 7. In addition, on the other stage of the two-stage transmission 7, which is associated with the output gear 13 of the axle differential 8, a further shifting element 14 is provided by means of which the two-stage transmission 7 and the electric machine 6 can be decoupled from the axle differential 8 when the shifting element 14 is open.

From the shifting scheme in FIG. 3A the same functions or drive ranges emerge as from the shifting scheme in FIG. 2A. Thus, purely electric driving, boosting or charging while driving, charging while the vehicle is at rest and synchronization of the electric machine 6 are all possible.

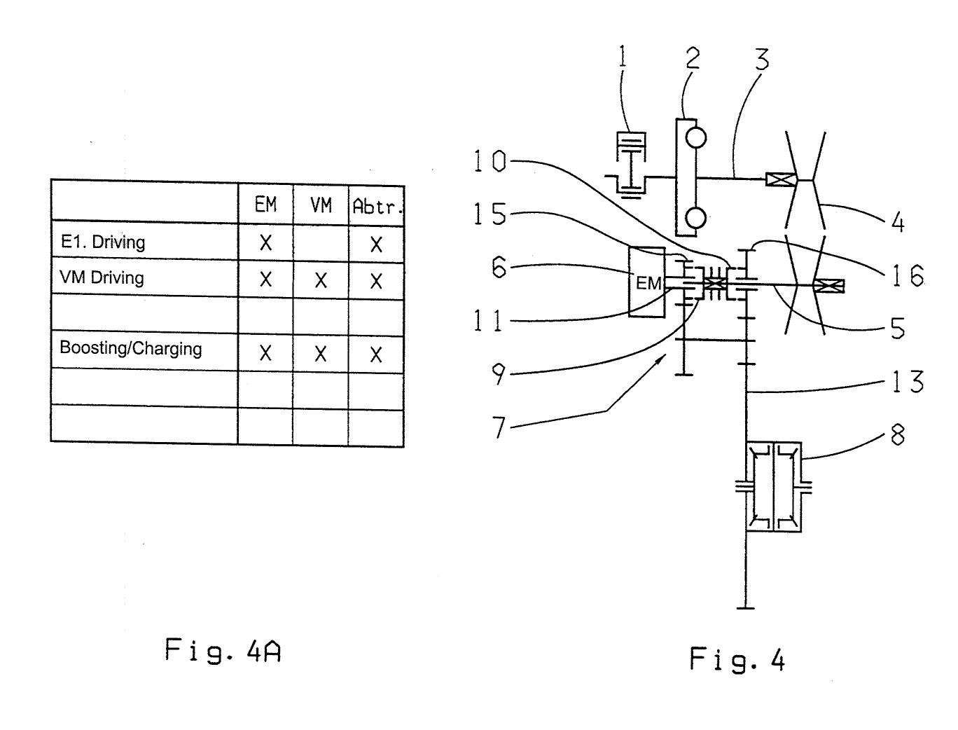

FIG. 4 shows a further embodiment variant in which two shifting elements 9 and 10 associated with the output shaft 5 of the continuously variable transmission 4 are provided, which are actuated by a common actuator. The electric machine 6 has a drive output shaft 11 in the form of a hollow shaft, on which there is a fixed wheel 15 that engages with one stage of the two-stage transmission 7. The output shaft 5 of the continuously variable transmission 4 is fitted to rotate inside the output shaft 11 made as a hollow shaft.

Thus, in its closed condition the shifting element 9 can enable a connection between the internal combustion engine 1 and the electric machine 6 and axle differential 8. The shifting element 10 is associated with a loose wheel 16 arranged on the output shaft 5 of the continuously variable transmission 4. Thus, when the shifting element 10 is closed a connection can be formed via the other stage of the two-stage transmission 7 to the axle differential 8. Since the shifting element 9 is open, during driving under internal combustion engine power decoupling from the electric machine 6 is possible.

Besides the driving ranges and functions of the embodiment variants described previously, in this case a further driving range is obtained since internal combustion engine driving can take place both by way of one stage and by way of the other stage of the two-stage transmission 7. Thereby two additional, different gear ratios can be obtained and accordingly, for example, the continuously variable transmission 4 can have a smaller speed.

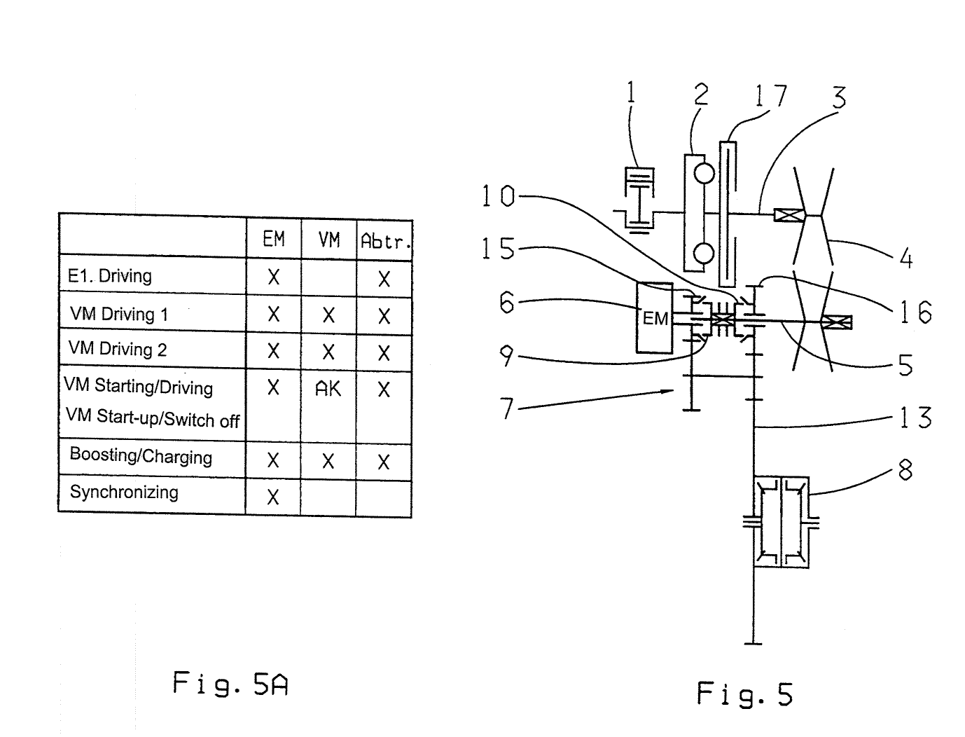

FIG. 5 shows a fifth embodiment variant, which differs from the fourth embodiment variant in that additionally, it comprises a starting clutch 17 between the internal combustion engine 1 and the continuously variable transmission 4. The shifting elements 9 and 10 are also provided. The shifting element 9 again faces toward the fixed wheel 15 arranged on the output shaft 11 made as a hollow shaft, and the shifting element 10 is again associated with the loose wheel 16 provided on the output shaft 5 of the continuously variable transmission 4.

As in the embodiment variants already described, a number of driving ranges can be obtained. Besides purely electric driving it is also possible, as with the fourth embodiment variant, for internal combustion engine driving to take place both via one stage and via the other stage of the two-stage transmission 7 (VM driving 1 and VM driving 2). Furthermore, by virtue of the starting clutch 17 provided an internal combustion engine start is also enabled (VM start/drive). In addition, the internal combustion engine can be started up or switched off as further driving ranges. As already mentioned for the previous embodiment variants, with this variant too boosting/charging and synchronization are possible as driving ranges.

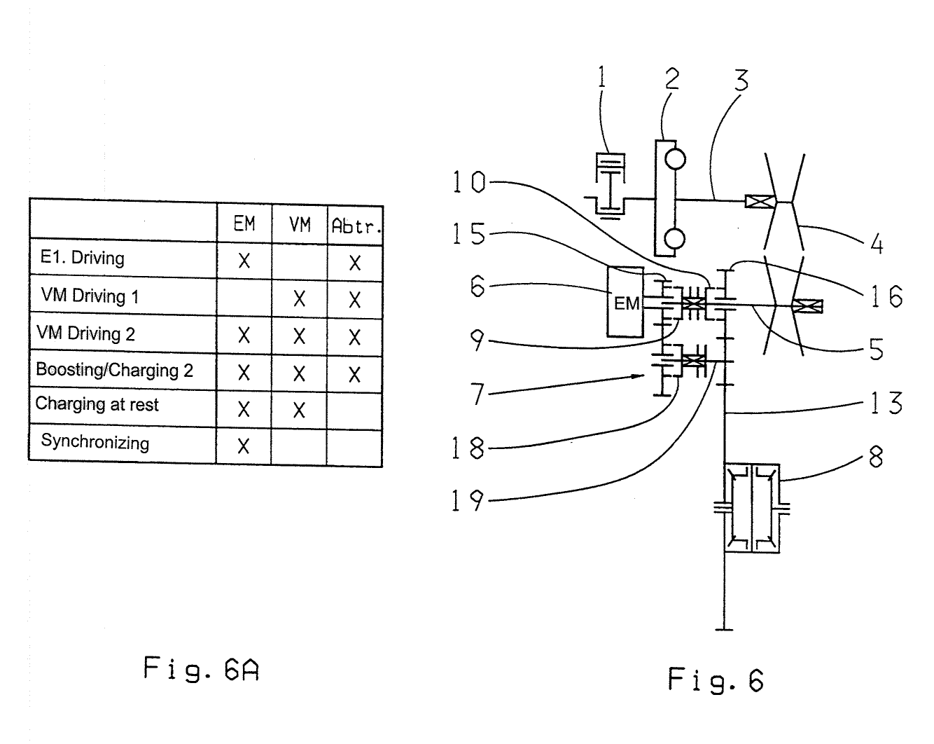

FIG. 6 shows a sixth embodiment variant of the drive-train, which differs from the fifth variant in that it comprises still another shifting element 18 on the transmission shaft 19 of the two-stage transmission 7. As can be seen in particular from the shifting scheme according to FIG. 6A, by virtue of the additional shifting element 18 the battery can also be charged with the vehicle at rest by means of the internal combustion engine 1 and the electric machine 6 switched to operate as a generator, since when the shifting elements 10 and 18 are both open the drive output is decoupled both from the internal combustion engine 1 and from the electric machine 6.

With this sixth embodiment variant the driving ranges available are electric driving, internal combustion engine driving both via one and via the other stage of the two-stage transmission 7 (VM driving 1 and VM driving 2), boosting/charging 2 for example via the second stage of the two-stage transmission 7, charging while at rest, and synchronization.

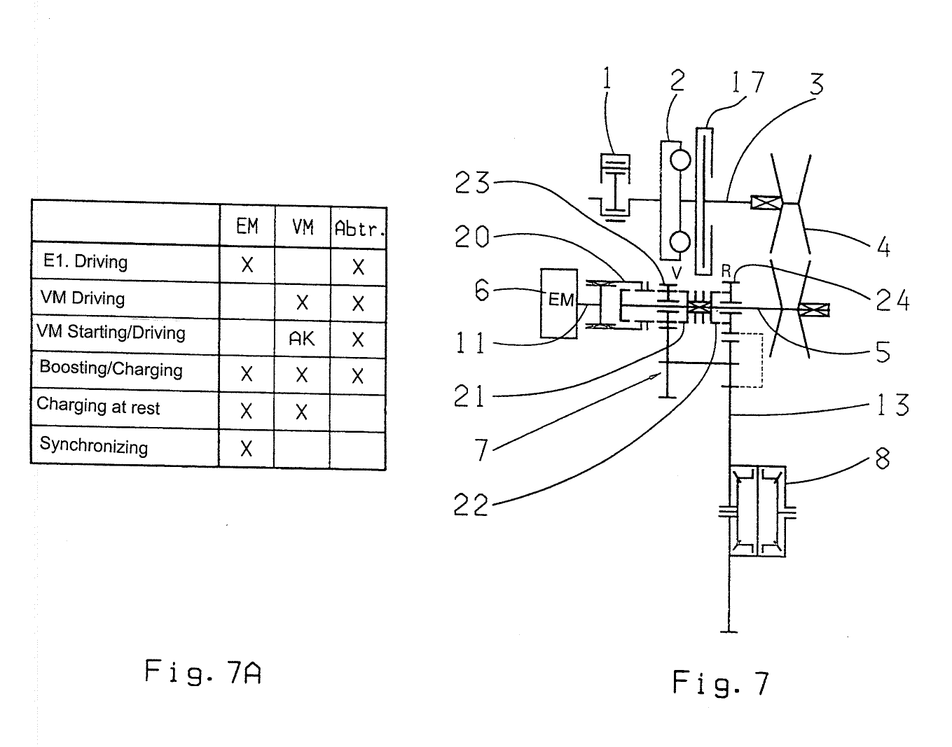

FIG. 7 shows a seventh embodiment variant of the drive-train in which a starting clutch 17 is again arranged between the internal combustion engine 1 and the continuously variable transmission 4. In addition, in this embodiment variant three shifting elements 20, 21 and 22 are provided. The shifting element 20 is associated with the output shaft 11 of the electric machine 6 and the shifting elements 21 and 22 are both associated with the output shaft 5 of the continuously variable transmission 4.

In FIG. 7 the shifting element 20 is shown in its neutral position. Referring to the plane of the drawing, when the shifting element 20 is moved out of the neutral position and to the left, the output shaft 11 of the electric machine 6 is connected to the output shaft 5 of the continuously variable transmission. Referring again to the plane of the drawing, when the shifting element 20 is moved out of the neutral position and to the right, the output shaft 11 of the electric machine 6 is connected, via the loose wheel 23, to a stage of the two-stage transmission 7, so as to drive the vehicle in the forward direction V.

In its closed condition the shifting element 21 can connect the output shaft 5 of the continuously variable transmission 4, via the loose wheel 23, to a stage of the two-stage transmission 7, to enable the vehicle to be driven in the forward direction V by the internal combustion engine.

In its closed condition the shifting element 22 can connect a loose wheel 24 to the output shaft 5 of the continuously variable transmission 4. As indicated in FIG. 7 by a broken line, by an appropriate spatial arrangement of the shafts the loose wheel 24 can be permanently connected to the output wheel 13 of the axle differential 8, so that when the shifting element 22 is closed a rotational speed reversal is produced, in order to drive in reverse R under internal combustion engine power or produce a reversing gear.

All in all, therefore, the proposed drive-train can meet the requirements described at the start with the fewest possible components and hence inexpensively. Moreover, it is also possible to start up the engine with interruption of the traction force when the drive-train comprises at least one shifting element by means of which the drive output can be decoupled as described earlier. To prevent traction force interruption during range shifts, the electric machine 6 can support the traction force of the internal combustion engine 1, as described in particular for the fourth to sixth embodiment variants.

If the starting clutch 17 arranged before the internal combustion engine 1 is in the form of a clutch, then the engine can even be started without traction force interruption if the electric machine 6, in addition to the instantaneous drive torque, also provides the friction torque acting at the clutch 17 with a corresponding gear ratio.

### INDEXES

1 Internal combustion engine (VM)
2 Vibration damper
3 Input shaft of the continuously variable transmission
4 Continuously variable transmission
5 Output shaft of the continuously variable transmission
6 Electric machine (EM)
7 Additional, two-stage transmission
8 Axle differential (Abtr.)
9 Shifting element
10 Shifting element
11 Output shaft of the electric machine
12 Loose wheel
13 Output gear of the axle differential
14 Shifting element
15 Fixed wheel
16 Loose wheel
17 Starting clutch
18 Shifting element
19 Transmission shaft of the two-stage transmission
20 Shifting element
21 Shifting element
22 Shifting element
23 Loose wheel
24 Loose wheel
V Forward driving
R Reverse driving

1-12. (canceled)

13. A drive-train of a vehicle comprising:
an internal combustion engine (1) and a continuously variable transmission (4) for driving under internal combustion engine power,
at least one electric machine (6) for driving under electric power, and
a drive output side of the electric machine (6) being connectable such that electric driving is carried out decoupled from the continuously variable transmission (4).

14. The drive-train according to claim 13, wherein at least one shifting element (9, 10, 21) decouples the electric machine (6) from the output shaft (5) of the continuously variable transmission (4).

15. The drive-train according to claim 13, wherein a multi-stage transmission (7), and with an axle differential (8), is associated with the electric machine (6) on an output side thereof.

16. The drive-train according to claim 15, wherein the electric machine (6) is decoupled by at least one shifting element (9, 14, 18) from at least one of the multi-stage transmission (7) and the axle differential (8).

17. The drive-train according to claim 15, wherein, during internal combustion engine driving, the output shaft (5) of the continuously variable transmission (4) is coupled with the axle differential (8) by at least one shifting element (9, 10, 18, 20, 21, 22) by way of the multi-stage transmission (7).

18. The drive-train according to claim 13, wherein the drive-train comprises a plurality of shifting elements (9, 10; 21, 22) which are all actuated by a common actuator.

19. The drive-train according to claim 13, wherein the drive-train comprises a two-stage transmission (7) and at least one stage is used as a gear ratio for forward driving (V) and another stage as a gear ratio for reversing (R).

20. The drive-train according to claim 19, wherein for the forward gear ratio (V), a loose wheel (23) is associated with an output shaft (5) of the continuously variable transmission (4), which meshes with a stage of the two-stage transmission (7), and the loose wheel (23) is connectable by a shifting element (21) to the output shaft (5), such that the forward gear ratio is shifted to facilitate either electric driving or internal combustion engine driving.

21. The drive-train according to claim 19, wherein for the reverse gear ratio, a loose wheel (24) is associated with an output shaft (5) of the continuously variable transmission (4), which meshes with an output gear (13) of the axle differential (8), and by way of a shifting element (22), the loose wheel (24) is connectable to the output shaft (5) such that the reverse gear ratio is engaged for internal combustion engine driving.

22. The drive-train according to claim 13, wherein an input shaft (3) of the continuously variable transmission (4) is connected to a vibration damper (2).

23. The drive-train according to claim 13, wherein an input shaft (3) of the continuously variable transmission (4) is connected to a starting clutch (17).

24. The drive-train according to claim 13, wherein as the continuously variable transmission (4) is a dry-running CVT transmission.

25. A drive-train of a vehicle comprising:
an internal combustion engine (1) and a continuously variable transmission (4) for driving under internal combustion engine power;
at least one electric machine (6) for driving under electric power, and
the electric machine (6) comprises a drive output being couplable to the drive train such that electric driving is carried out when the continuously variable transmission (4) is decoupled from the drive train.

26. A drive-train of a vehicle comprising:
an internal combustion engine (1) and a continuously variable transmission (4) for driving an output of the drive train under internal combustion engine power,
at least one electric machine (6) for driving the output of the drive train under electric power, and
a drive output side of the electric machine (6) being connectable such that electric driving of the output of the drive train is carried out such that the electric machine (6) is decoupled from the continuously variable transmission (4).
